(19) United States
(12) Patent Application Publication
(10) Pub. No.: US 2007/0126556 A1
(43) Pub. Date: Jun. 7, 2007

(54) Printed radio frequency identification (RFID) tag using tags-talk-first (TTF) protocol

(75) Inventors: Vivek Subramanian, Orinda, CA (US); Vikram Pavate, San Mateo, CA (US)

Correspondence Address: THE LAW OFFICES OF ANDREW D. FORTNEY, PH.D., P.C., 401 W FALLBROOK AVE STE 204, FRESNO, CA, 93711-5835, US

(73) Assignee: Kovio, Inc.

(21) Appl. No.: 11/544,366

(22) Filed: Oct. 6, 2006

Related U.S. Application Data
(60) Provisional application No. 60/748,973, filed on Dec. 7, 2005.

(51) Int. Cl. H04Q 5/22

(52) U.S. Cl. 340/10.4; 340/572.1; 340/10.34; 340/10.2

(57) ABSTRACT

A method, algorithm, architecture, circuits, and/or systems for EAS, HF, UHF, and RFID designs suitable for multi-tag read applications using TTF anti-collision schemes are disclosed. In one embodiment, a tag for wirelessly communicating with a reader can include: (i) a memory portion with an identifier, the memory having at least one printed layer; and (ii) a circuit for providing a bit string followed by a predetermined silent period, where the bit string is related to the identifier. The tag can include pre-programmed memory bits (e.g., bits the value of which is programmed by printing), or alternatively, memory bits formed by conventional photolithography, but having connections made using printing technology to form the identifier, for example. A unique identifier for each tag or device used in a system under a given set of operating conditions can allow a reader to distinguish between them based on a length and/or value of a bit string, for example. Embodiments of the present invention can advantageously provide a reliable and simplified approach for multi-tag read capable EAS, HF, UHF, and RFID systems using TTF anti-collision schemes.

### RELATED APPLICATIONS

This application claims the benefit of U.S. Provisional Application No. 60/748,973, filed Dec. 7, 2005 (Attorney Docket No. IDR0641), which is incorporated herein by reference in its entirety.

### FIELD OF THE INVENTION

The present invention generally relates to the field of electronic article surveillance (EAS), high frequency (HF), ultrahigh frequency (UHF), radio frequency (RF) and/or RF identification (RFID) tags and devices. More specifically, embodiments of the present invention pertain to EAS, HF, UHF, RF and/or RFID structures and methods of manufacture and/or production.

### DISCUSSION OF THE BACKGROUND

Low cost RFID systems, typically including an interrogator or “reader” and an electronic label or “tag,” are desirable in a variety of applications, such as retail, supply chain management, logistics, library management, and baggage claim systems, as just a few examples. Other emerging applications include vehicle toll tracking and/or management. One advantage of RFID systems over conventional barcode and magnetic media-based systems is that RFID systems can be configured to read multiple electronic labels simultaneously. Such a multi-tag capability can enable faster automated data capture and identification, leading to faster and more efficient inventory tracking, sorting, and handling operations, for example.

Referring now to FIG. 1, a block diagram showing a conventional RFID tag system in which the reader interacts with only a single tag at a time, indicated by the general reference character 100. Computer 102 can connect to interrogation source 104, which can then communicate to tag 110 via antenna 106. Tag 110 can provide information wirelessly to antenna 106 that can then be captured by detector 108 and fed back into computer 102. Tag 110 can, for example, provide a simple bit string of data back to computer 102. For example, in a retail application, tag 110 can convey to computer 102 whether a particular item has been purchased or not. In many applications, some or all of 102, 104, 106, and 108 may be combined into a common physical entity, commonly called a “reader”.

Referring now to FIG. 2, a diagram showing a conventional tag system application for reading multiple tags simultaneously is indicated by the general reference character 200. Toll station 206 can employ a tag system to determine whether cars passing through have arranged for payment (e.g., via a debit or a credit account) to access a road, as an alternative to each car stopping in order to pay a person in a booth at the toll station. Each car passing through may have an associated tag attached to the vehicle (e.g., tags 202-0, 202-1, and 202-2). An applied electromagnetic field can include RF waves 208 to pass information between interrogator/reader 204 and each of tags 202-0, 202-1, and 202-2. Other such multi-tag read applications include retail, library or inventory management, security, and animal (e.g., pet) identification, for example.

In expanding typical RFID systems to support multi-tag read capability, anti-collision blocks and/or algorithms can be employed with the interrogator and electronic label or tag. Two common classes of anti-collision schemes are “tags-talk-first” (TTF) and “reader-talks-first” (RTF). In a TTF approach, the electronic label can broadcast intermittently as long as it is within a sustained electromagnetic field of the interrogator. This field must be maintained for a period of time greater than a time interval between the intermittently repeated label replies. In an RTF scheme, the interrogator and an electronic label to be read must set up a communication link whereby the electronic label can interpret and transmit based on commands and arbitration schemes from the interrogator. An RTF approach is generally more complex in both interrogator and label designs (e.g., the number of transistors in the label circuit). As a result, a drawback of this approach is its relatively high cost, making it prohibitively expensive for many anticipated applications.

On the other hand, both interrogator and electronic label circuit designs using the TTF approach are generally simpler, thus supporting a lower overall system cost. Recent conventional implementations of TTF within the electronic label generally require a message interval circuit that may be fixed in content at the time of manufacture, programmable at the time of use, or possibly re-programmed in operation. However, the typical method of manufacturing electronic label circuits generally uses conventional photolithography. Because of a general processing aim to decrease variation across wafers, such conventional photolithographic techniques may actually result in insufficient variation for message interval circuitry design in multi-tag read applications.

One conventional method of overcoming insufficient variation in the message interval circuitry design is to utilize a pseudo-random number generator circuit. Pseudo-random numbers can be used in the label design to create sufficient differences in the message interval between multiple tags communicating with the same interrogator. However, such a pseudo-random number generator circuit may be relatively complex for a label design, resulting in costs that are too high for use in many anticipated EAS and/or RFID system applications. What is needed is a simplified and cost-effective approach to making EAS and/or RFID systems suitable for multi-tag read applications using TTF anti-collision schemes.

### SUMMARY OF THE INVENTION

Embodiments of the present invention relate to methods, algorithms, architectures, circuits, and/or systems for EAS, HF, UHF and/or RFID designs suitable for multi-tag read applications using TTF anti-collision schemes.

In one embodiment, a tag for wirelessly communicating with a reader can include: (i) a memory portion with an identifier, the memory having at least one printed layer; and (ii) a circuit for providing a bit string followed by a predetermined silent period, where the bit string is related to the identifier. The tag or device can include pre-programmed memory bits (e.g., bits the value of which is programmed by printing), or alternatively, memory bits formed by conventional photolithography, but having connections made using printing technology to form the identifier, for example. A unique identifier for each tag or device used in a system under a given set of operating conditions can allow a reader to distinguish between multiple tags based on a length and/or value of a bit string, for example.

In another embodiment, a method of operating an identification tag or device in a wireless communication system can include: (i) programming an identifier in the tag using a printing technology; (ii) transmitting a bit string based on the identifier to a reader when the tag is in an electromagnetic field having a power and frequency sufficient for the tag to operate; and (iii) silencing the tag for a predetermined time period. The printing technology can include laser printing, screen-printing, flexographic printing, offset printing, ink jetting, gravure printing, laser writing, and/or laser definition technology, perhaps using a metal nanoparticle- and/or liquid silane-based ink.

In another embodiment, a method of operating an identification tag or device in a wireless communication system can include: (i) programming an identifier in the tag using a printing technology; (ii) transmitting a bit string based on the identifier to a reader when the tag is in an electromagnetic field having a power and frequency sufficient for the tag to operate; and (iii) silencing the tag for a time period unique to the tag. Generally, the “silent period” is dependent on various environmental and physical variables, such as the power available to the tag, and variations in functionality and/or programming of electronic components within the tag. In addition, the “unique” time period refers to a probability that no other tag in a given set or population of tags reasonably likely to be within a detection and/or response range of a reader at a given point in time will be silent for the same period of time (within detection limits of the reader).

In another embodiment, a wireless identification system can include: (i) a first tag with a first identifier programmed therein using printing technology, where the first tag provides a first bit string of a first length and/or value when an electromagnetic field is applied, and where the first length and/or value is determined by an algorithm based on the first identifier; (ii) a second tag with a second identifier programmed therein using printing technology, where the second tag provides a second bit string of a second length and/or value when the electromagnetic field is applied, and where the second length and/or value is also determined by the algorithm based on the second identifier; and (iii) a reader for receiving the first and second bit strings when the electromagnetic field is applied, where the reader can distinguish between the first and second lengths and/or values.

Embodiments of the present invention can advantageously provide a reliable and simplified approach for multi-tag read capable EAS, HF, UHF and RFID systems using TTF anti-collision schemes. Further, embodiments of the present invention can advantageously be implemented using printing technology. These and other advantages of the present invention will become readily apparent from the detailed description of preferred embodiments below.

### BRIEF DESCRIPTION OF THE DRAWINGS

FIG. 1 is a block diagram showing a conventional RF identification (RFID) tag system for a single tag application.

FIG. 2 is a diagram showing a conventional tag system application for reading multiple tags simultaneously.

FIG. 3 is a layout diagram showing an exemplary tag layout in accordance with embodiments of the present invention.

FIG. 4A is an exemplary block schematic diagram showing an HF tag design in accordance with embodiments of the present invention.

FIG. 4B is an exemplary block schematic diagram showing a UHF tag design in accordance with embodiments of the present invention.

FIG. 5 is an exemplary block schematic diagram showing an RFID design suitable for use in accordance with embodiments of the present invention.

FIGS. 6A-6B are exemplary block schematic diagrams showing various tag designs in accordance with embodiments of the present invention.

FIG. 7 is a flow diagram showing an exemplary method of tag operation in accordance with embodiments of the present invention.

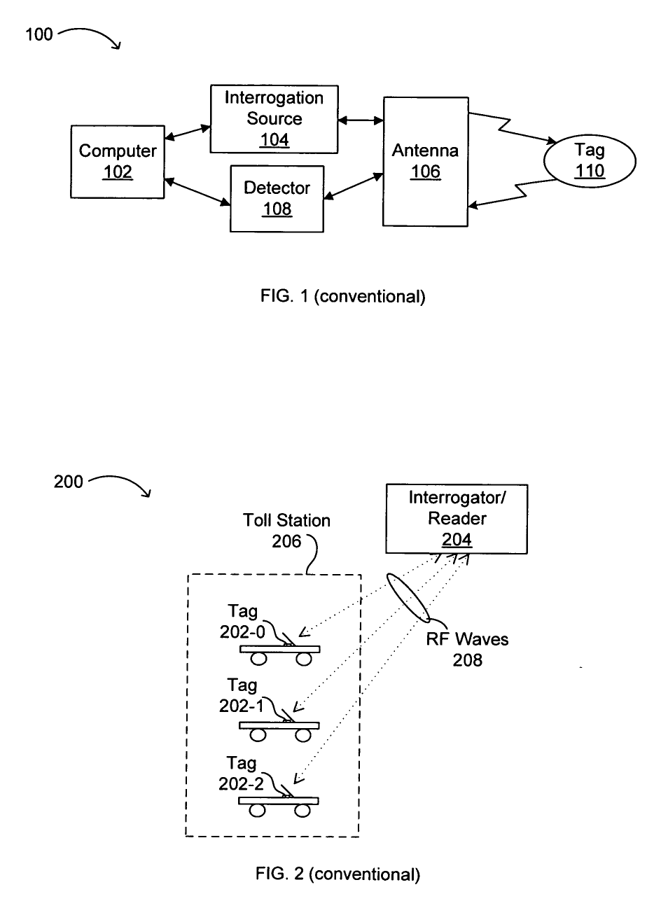

### DETAILED DESCRIPTION OF THE PREFERRED EMBODIMENTS

Reference will now be made in detail to the preferred embodiments of the invention, examples of which are illustrated in the accompanying drawings. While the invention will be described in conjunction with the preferred embodiments, it will be understood that they are not intended to limit the invention to these embodiments. On the contrary, the invention is intended to cover alternatives, modifications and equivalents that may be included within the spirit and scope of the invention as defined by the appended claims. Furthermore, in the following detailed description of the present invention, numerous specific details are set forth in order to provide a thorough understanding of the present invention. However, it will be readily apparent to one skilled in the art that the present invention may be practiced without these specific details. In other instances, well-known methods, procedures, components, and circuits have not been described in detail so as not to unnecessarily obscure aspects of the present invention.

Some portions of the detailed descriptions that follow are presented in terms of processes, procedures, logic blocks, functional blocks, processing, and other symbolic representations of operations on code, data bits, data streams or waveforms within a computer, processor, controller and/or memory. These descriptions and representations are generally used by those skilled in the data processing arts to effectively convey the substance of their work to others skilled in the art. A process, procedure, logic block, function, process, etc., is herein, and is generally, considered to be a self-consistent sequence of steps or instructions leading to a desired and/or expected result. The steps generally include physical manipulations of physical quantities. Usually, though not necessarily, these quantities take the form of electrical, magnetic, optical, or quantum signals capable of being stored, transferred, combined, compared, and otherwise manipulated in a computer or data processing system. It has proven convenient at times, principally for reasons of common usage, to refer to these signals as bits, waves, waveforms, streams, values, elements, symbols, characters, terms, numbers, or the like, and to their representations in computer programs or software as code (which may be object code, source code or binary code).

It should be borne in mind, however, that all of these and similar terms are associated with the appropriate physical quantities and/or signals, and are merely convenient labels applied to these quantities and/or signals. Unless specifically stated otherwise and/or as is apparent from the following discussions, it is appreciated that throughout the present application, discussions utilizing terms such as “processing,” “operating,” “computing,” “calculating,” “determining,” “manipulating,” “transforming” or the like, refer to the action and processes of a computer or data processing system, or similar processing device (e.g., an electrical, optical, or quantum computing or processing device or circuit), that manipulates and transforms data represented as physical (e.g., electronic) quantities. The terms refer to actions and processes of the processing devices that manipulate or transform physical quantities within the component(s) of a circuit, system or architecture (e.g., registers, memories, other such information storage, transmission or display devices, etc.) into other data similarly represented as physical quantities within other components of the same or a different system or architecture.

Furthermore, in the context of this application, the terms “wire,” “wiring,” “line,” “signal,” “conductor” and “bus” refer to any known structure, construction, arrangement, technique, method and/or process for physically transferring a signal from one point in a circuit to another. Also, unless indicated otherwise from the context of its use herein, the terms “known,” “fixed,” “given,” “certain” and “predetermined” generally refer to a value, quantity, parameter, constraint, condition, state, process, procedure, method, practice, or combination thereof that is, in theory, variable, but is typically set in advance and not varied thereafter when in use.

Similarly, for convenience and simplicity, the terms “clock,” “time,” “timing,” “rate,” “period” and “frequency” are, in general, interchangeable and may be used interchangeably herein, but are generally given their art-recognized meanings. Also, for convenience and simplicity, the terms “data,” “data stream,” “bits,” “bit string,” “waveform” and “information” may be used interchangeably, as may the terms “connected to,” “coupled with,” “coupled to,” and “in communication with,” (which may refer to direct or indirect connections, couplings, or communications) but these terms are generally given their art-recognized meanings herein. Further, a “tag” may refer to a single device or to a sheet and/or a spool comprising a plurality of attached structures, suitable for electronic article surveillance (EAS), high frequency (HF), ultrahigh frequency (UHF), radio frequency (RF) and/or RF identification (RFID) purposes and/or applications.

Embodiments of the present invention relate to methods, algorithms, architectures, circuits, and/or systems for EAS and/or RFID designs suitable for multi-tag read applications using TTF anti-collision schemes. For example, a tag for wirelessly communicating with a reader can include: (i) a memory portion with an identifier, the memory having at least one printed layer; and (ii) a circuit for providing a bit string followed by a silent period, where the bit string is related to the identifier. The tag or device can include pre-programmed memory bits (e.g., bits the value of which may be programmed by printing), or alternatively, memory bits formed by conventional photolithography, but having connections made using printing technology to form the identifier, for example. A unique identifier for each tag or device used in a system under a given set of operating conditions can allow a reader to distinguish between multiple tags based on a length and/or value of a bit string, for example.

In another aspect of the invention, a method and/or algorithm of operating an identification tag or device in a wireless communication system, can include: (i) programming an identifier in the tag using a printing technology; (ii) transmitting a bit string based on the identifier to a reader when the tag is in an electromagnetic field having a power and frequency sufficient for the tag to operate; and (iii) silencing the tag for a predetermined time period. The printing technology can include laser printing, ink jetting, gravure printing, laser writing, and/or laser definition technology, perhaps using metal nanoparticle and/or liquid silane-based ink.

In another aspect of the invention, a method and/or algorithm of operating an identification tag or device in a wireless communication system, can include: (i) programming an identifier in the tag using a printing technology; (ii) transmitting a bit string based on the identifier to a reader when the tag is in an electromagnetic field having a power and frequency sufficient for the tag to operate; and (iii) silencing the tag for a time period unique to the tag. Generally, the “silent period” is determined by variations in various environmental and physical parameters, such as power delivered to the tag, temperature, electromagnetic interference (EMI), etc., and variations in electrical performance and/or programming of various components within the tag circuitry. The printing technology can include laser printing, ink jetting, gravure printing, laser writing, and/or laser definition technology, perhaps using metal nanoparticle and/or liquid silane-based ink.

In another aspect of the invention, a wireless identification system can include: (i) a first tag with a first identifier programmed therein using printing technology, where the first tag repeatedly broadcasts a first bit string of a first length and/or value, followed by a silent period, when an electromagnetic field is applied, where the first length and/or value is determined by an algorithm based on the first identifier; (ii) a second tag with a second identifier programmed therein using printing technology, where the second tag provides a second bit string of a second length and/or value, followed by a second silent period, when the electromagnetic field is applied, where the second length and/or value is also determined by the algorithm based on the second identifier; and (iii) a reader for receiving the first and second bit strings when the electromagnetic field is applied, where the reader can distinguish between the first and second lengths and/or values.

The invention further relates to multi-tag system implementations of the present architecture, method and circuit. Embodiments of the present invention can advantageously provide a reliable and simplified approach for multi-tag read capable EAS, HF, UHF, and RFID systems using TTF anti-collision schemes. Further, embodiments of the present invention can advantageously be implemented using printing technology. The invention, in its various aspects, will be explained in greater detail below with regard to exemplary embodiments.

According to various embodiments of the present invention, an architecture or circuit for enabling multi-tag read capable EAS, HF, UHF, and RFID systems can include a printed circuit employing a relatively simple tags-talk-first (TTF) anti-collision scheme. Further, the circuit can be relatively easy to print and may provide tags or electronic labels with a unique message interval based on the application. Also, the associated interrogator or reader device design can also be relatively simple. Embodiments of the present invention are particularly suitable for relatively fast read time applications with insufficient time for a reader and electronic label to form a communication link and process a typical reader-tag command structure and anti-collision arbitration scheme (e.g., as may be required in RTF approaches, as discussed above).

In accordance with embodiments of the present invention, relatively low cost manufacturing methods, including simple printing techniques, such as laser printing, ink jetting, gravure printing, laser writing, and/or laser definition technology using metal nanoparticle and/or liquid silane-based inks may be used (see, e.g., U.S. Provisional Patent Application No. 60/697,599, filed on Jul. 8, 2005, as Attorney Docket No. IDR0501, and U.S. Patent Application Nos. 11/249,167, 11/246,014, 11/243,460, 11/203,563, 11/104,375, 11/084,448, 10/956,714, 10/950,373, 10/949,013, 10/885,283, 10/789,317, 10/749,876, and/or 10/722,255, respectively filed on Oct. 11, 2005, Oct. 6, 2005, Oct. 3, 2005, Aug. 11, 2005, Apr. 11, 2005, Mar. 18, 2005, Oct. 1, 2004, Sep. 24, 2004, Sep. 24, 2004, Jul. 6, 2004, Feb. 27, 2004, Dec. 31, 2003 and Nov. 24, 2003). For example, semiconductor layers (e.g., containing doped and/or undoped silicon or silicon-germanium) can be printed from an ink comprising silicon and/or germanium nanoparticles and/or a liquid-phase silane, germane and/or silagermane in a suitable solvent. For example, the silane, germane or silagermane may have the formula AₓH_{y} where each A is independently Si or Ge (preferably Si), x is from 3 to 1000 (preferably from 4 to 20, or 5 to 10) and where x may be derived from an average number molecular weight of the silane, germane and/or silagermane when x≧10 or 20, and y is from x to (2x+2) (preferably 2x). Metal layers may be printed from an ink comprising nanoparticles of a metal (such as silver, copper, gold, palladium, molybdenum, aluminum, etc.) in a suitable solvent. Preferred solvents include cycloalkanes such as cyclohexane, cyclooctane, decalin, etc.

In general, a printed circuit in accordance with embodiments of the present invention can include: an antenna section, a power-up circuit, a clock subcircuit, a counter, a memory portion, a decoder, a loop reset circuit, and an output stage. All such circuit portions can be printable in order to reduce overall system costs. As a result, “on-the-fly” customization of individual tags during the manufacturing process can also be accommodated.

An alternate embodiment of a printed circuit in accordance with embodiments of the present invention can include: an antenna section, a power-up circuit, a clock subcircuit, a memory portion, cyclic counters for selecting specific bits within the memory, a circuit with variable delay, and an output stage. All such circuit portions can be printable in order to reduce overall system costs. As a result, “on-the-fly” customization of individual tags during the manufacturing process can also be accommodated.

A tag operating in accordance with embodiments of the present invention can generally perform: (i) after initial power-up, transmittal of a bit string (which may have been laser-programmed into memory); (ii) silencing the tag for a period of time (this length of time may also have been laser-programmed into memory, or may be determined by various environmental and physical parameters); and (iii) re-broadcasting the bit string. Generally, the process of bit string transmission, a silent period, followed by a re-transmission of the bit string, can continue so long as the tag remains in an applicable electromagnetic field (e.g., the tag receives power).

Exemplary RFID Tag Structures

Exemplary RFID tag structures and devices can generally include functional blocks, such as: (i) antennae; (ii) RF-to-DC conversion; iii) demodulation of clock and data signals; (iv) logic to perform control and readout (I/O) functions; (v) memory; and (vi) modulation. Specific examples involving these and other functional blocks and layout arrangements will be discussed in more detail below.

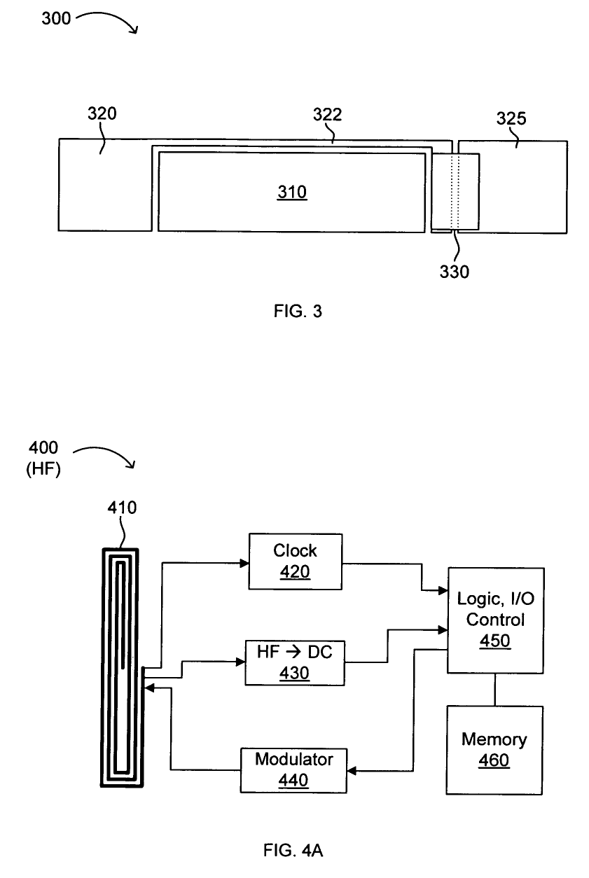

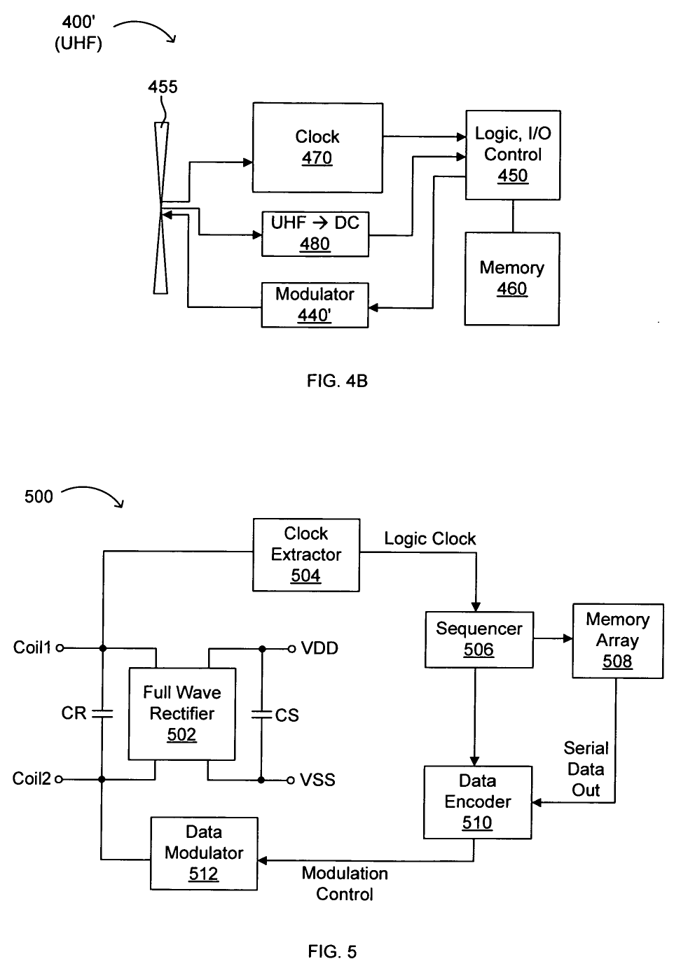

FIG. 3 shows an exemplary layout for tag or device 300, including logic region 310, antenna regions 320 and 325, and charge pump area 330. The device 300 may have a length of from 5 to 25 mm, preferably 5 to 20 mm, a width of from 1 to 5 mm, preferably 1 to 3 mm, and an overall area of from 5 to 100 mm², preferably 10 to 50 mm². In one example, the device is 2 mm×12.5 mm. As will be discussed in more detail with regard to FIGS. 4A-4B, logic region 310 may further comprise an input/output control portion, a memory or information storage portion, a clock recovery portion, and/or an information/signal modulation portion.

Antenna region 320 is coupled to charge pump region 330 by L-shaped bus 322. A part of charge pump region 330 also overlaps with antenna region 325. Charge pump region 330 is conventionally coupled to antenna regions 320 and 325 by capacitors, diodes and/or interconnects. For example, charge pump region 330 may comprise a plurality of stages (in one specific example, 8 stages), and the capacitors therein may have an area of 100 to 400 square microns per antenna overlap portion (i.e., the portion of charge pump 330 that overlaps with either bus 322 or antenna region 325).

A block diagram of a high frequency (HF) range tag design is shown in FIG. 4A (general reference character 400) and an ultra-high frequency (UHF) range tag design is shown in FIG. 4B (general reference character 400′). The HF tag design (400) comprises antenna 410, clock recovery block 420, HF-DC converter block 430, modulator block 440, logic and I/O control block 450, and memory 460. The UHF tag design (400′) comprises dipole antenna 455, clock recovery block 470, UHF-DC converter block 480, modulator block 440′, logic and I/O control block 450, and memory 460.

The antennae structures at HF are most inexpensively implemented as a planar spiral inductor coil with a resonant tank capacitor coupled thereto (e.g., in charge pump region 330 in FIG. 3). The low resistivity requirements for a high quality (high voltage/power extracting) LC coil necessitates the use of metal foils or thick printed films. In the UHF, the antenna is typically in a full or half-wave dipole or dipole-derivative form that supports transmission (and reception) of AC waves without significant DC conduction or long conduction distances as in a coil. Also, the skin depth of the excitation in the antennae is shallower in the UHF. For that reason, UHF antennae can be thin metal foils or even printed conductor films from materials such as Ag pastes. In certain design embodiments, the HF or UHF antennae could be formed directly in the underlying metal substrate for the integrated circuitry, or the substrate could form an interposer or strap (e.g., a thin plastic or glass sheet serving as a substrate for subsequent formation of silicon-based devices) of intermediate size (e.g., between that of the full antennae and that of the semiconductor device-containing integrated circuit area) that could then be attached to an external antennae.

RF-to-DC conversion can be achieved using rectifiers (typically in a voltage doubler configuration), or thin film diode structures formed from Si ink at UHF or HF. At HF, it is also possible to use diode-connected TFTs (i.e., having its gate connected to a source or drain of the same transistor). Modeling of thin film devices based on Si ink layers with mobilities of >10 cm²/vs in the diode transport direction, doping in the range of 10¹⁷-10²⁰ cm⁻³, and contact resistances on the order of 10⁻⁵ ohm-cm² would support rectification in the GHz regime, of sufficient efficiency to power an RFID circuit. GHz rectification to DC and <2 nsec gate delays have been demonstrated experimentally for a vertical thin film Si ink diode structure and a self-aligned TFT structure, respectively, formed as described herein.

Clock and data signals may be encoded as a subcarrier or as a subcarrier modulation on the carrier RF signal. Optimal signal extraction may require filtering and the use of tuned capacitors.

Logic to perform the required control and readout (I/O) functions can be realized with TFTs in CMOS or NMOS technologies, using materials as described herein. CMOS has a significant advantage in terms of power efficiency, but requires additional process steps compared to NMOS.

Memory structures can include simple read-only memory (ROM) provided by a digital resistive network, defined during the fabrication process. One-time programmable (OTP) ROM may comprise a conventional fuse or anti-fuse structure, and nonvolatile EEPROM in thin film form may comprise a TFT having a floating gate therein. Programming and erasing circuitry (and devices configured to withstand programming and erasing voltages) can also be designed conventionally and manufactured as described herein.

In the HF range, modulation is typically done by load modulation with a shunt transistor in parallel with the resonant capacitor. With a modulator TFT made from a silane ink formulation in enhancement mode, when the transistor is on, the LC coil that forms the tag's antenna is shorted. This dramatically reduces the Q of the circuit and the coupling to the reader coil. When the TFT is switched sufficiently ‘off,’ the Q of the LC coil is restored. In this way, a modulation signal can be passed from the tag to the reader. At UHF, similar effects also vary the scattering cross-section of the antenna and modulate the backscatter signal to the reader. This can be done with load modulation TFTs changing the impedance of the antenna, and therefore, the backscatter signal. Due to potential power losses, it may be advantageous to use a varactor-based modulation that shifts the imaginary part of the impedance of the UHF antennae using either a MOS capacitor device or a varactor diode that can be formed using the TFT and diode processes described herein for logic TFTs and for rectifier and/or demodulator diodes.

Layouts of thin film transistors configured for logic and memory have been designed in accordance with the present invention using 8 μm and 2 μm design rules. Under the 8 μm rules (assuming ±2 μm margin for registration/alignment variations), the average transistor area is about 9776 μm², and one can place about 100 transistors per mm². Under the 2 μm rules, the average transistor area is about 3264 μm², and one can place about 300 transistors per mm².

Typically, RFID tag operation is limited by the minimum RF field (and power) required to power the tag. Once the tag is able to power-up and sustain the required voltages, tag-to-reader communications are possible.

Referring now to FIG. 5, an exemplary block schematic diagram showing an RFID design suitable for use in accordance with embodiments of the present invention is indicated by the general reference character 500. An electromagnetic field can be induced on an external coil attached at terminals Coil1 and Coil2 and across capacitor CR. The AC voltage across the coil can be rectified by full wave rectifier 502 to form a DC supply across terminals VDD/VSS and supply capacitance, CS.

Clock extractor 504 can produce a logic clock for sequencer 506. Memory array 508 can be accessed by signals generated from sequencer 506 to provide serial data out to data encoder 510. Modulation control can be generated from data encoder 510 and provided to data modulator 512 for output to the reader.

An Exemplary Tag

An exemplary tag for wirelessly communicating with a reader can include: (i) a memory portion with an identifier, where the memory portion has at least one printed layer; and (ii) a circuit for providing a bit string followed by a predetermined silent period, where the bit string is related to the identifier. The tag can include pre-programmed memory bits (e.g., bits the value of which may be programmed by printing), or alternatively, memory bits formed by conventional photolithography, but having connections made using printing technology to form the identifier, for example. A unique identifier for each tag or device used in a system under a given set of operating conditions can allow a reader to distinguish between multiple tags based on a length and/or value of a bit string, for example.

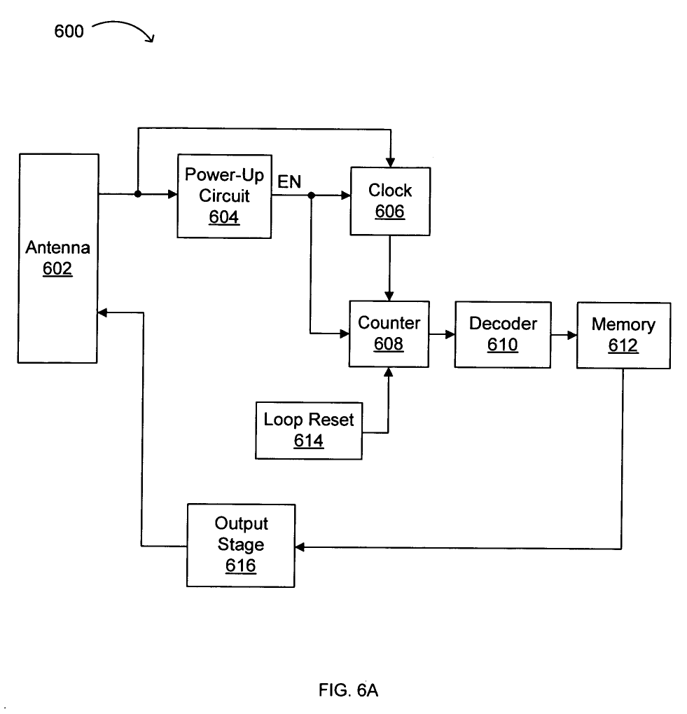

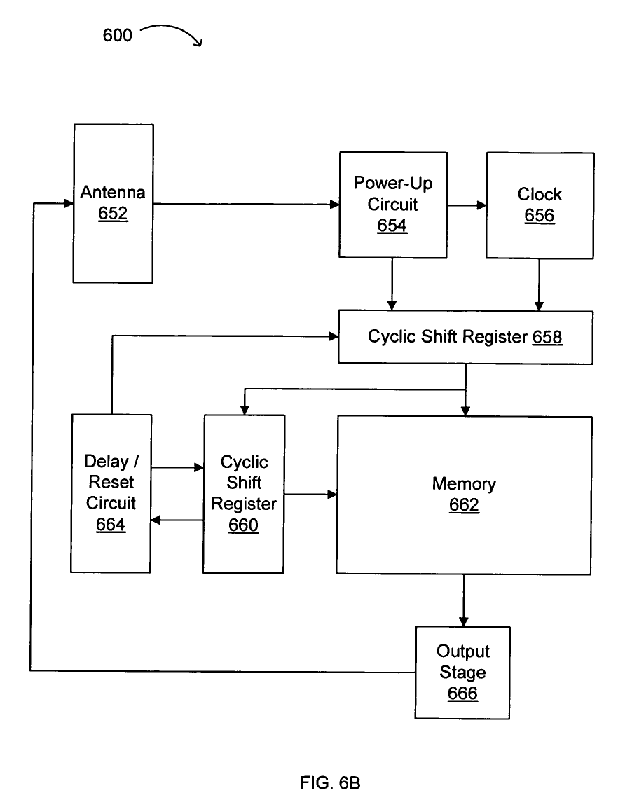

Referring now to FIG. 6A, an exemplary block schematic diagram showing a tag design in accordance with embodiments of the present invention is indicated by the general reference character 600. In general, a printed circuit in accordance with embodiments of the present invention can include: an antenna section (e.g., 602), a power-up circuit (e.g., 604), a clock subcircuit (e.g., 606), a counter (e.g., 608), a memory portion (e.g., 612), a decoder (e.g., 610), a loop reset circuit (e.g., 614), and an output stage (e.g., 616). Portions of or all such circuit portions can be printable in order to reduce overall system costs. Further, “on-the-fly” customization of individual tags during the manufacturing process can also be accommodated in accordance with embodiments of the present invention.

The antenna may be implemented using a resonant LC circuit for use at 13.56 MHz, for example. Alternatively, the antenna may be implemented using a dipole or similar such antenna for 900 MHz or 2.4 GHz operation. Generally, the antenna may be used to provide power for operation of the tag circuitry, and to provide information from the tag to the reader or interrogator. Using power-up circuit 604, power can be extracted by rectifying the RF signal collected by antenna 602 and storing the resultant charge in a storage capacitor. Thus, when a tag enters a region of space with sufficient electromagnetic field being transmitted from a nearby reader, the capacitor begins to charge-up, and a voltage across the capacitor increases accordingly. When the voltage reaches a sufficient value, an “enable” signal can be generated, and this enable signal (e.g., EN) can be used to initiate circuit operation (e.g., by coupling to clock 606 and counter 608).

In an exemplary clocking subcircuit (e.g., 606), a clock signal can be generated so as to synchronously operate associated circuitry (e.g., counter 608). This clock signal may be generated by dividing down the incident RF signal received by antenna 602, by generating a local clock signal using an on-chip oscillator, or by demodulating a reader-provided clock signal from the received RF signal. This clock signal may be used to drive counter 608, which may begin counting from a reset state as soon as tag circuitry 600 is enabled, for example.

As counter values increase, a counter output can be used to sequentially select specific bits in memory portion 612. Such a memory array in accordance with embodiments of the present invention may be customized using a maskless process technology (e.g., a printing process), as described above, for 1, 2, or more layers of the tag. In an alternative embodiment, memory bits forming memory 612 may be made using conventional photolithographic techniques, and outputs thereof can be connected using maskless processing (e.g., one or more of the printing and/or laser writing/definition processes listed herein) in order to create customized bit sequences. Such a customized memory may consume less device area as compared to memory bits generated by the shift register and/or pseudo-random number generator schemes discussed above.

Bits provided from memory 612 in tag or device 600 may be passed to output stage 616 for information (e.g., in the form of a bit string) transfer back to a reader or interrogator. The information transfer can be accomplished by modulation of the tag impedance, for example. Alternatively, other common modulation schemes, such as amplitude shift keying and/or frequency shift keying may also be used in accordance with embodiments of the present invention.

In operation, as counter 608 goes through its counting sequence, various bits or portions of a predefined bit string can be transferred back to the reader. Simultaneously, loop reset 614 can monitor the state of counter 608. After a complete bit string of appropriate length is sent back to the reader, tag 600 can “go silent” and remain in this silent state until the counter state reaches a specific value. Loop reset 614 can then compare the counter value with a value that may be programmed during tag fabrication using laser fuses, for example. When the counter value and the programmed value are logically equal (e.g., each bit of each value matches), loop reset circuit 614 can reset counter 608, and the overall process can be repeated.

Within a predetermined period of time (e.g., 1 second), X tags can broadcast and be read/distinguished by conventional RFID systems and/or technology. “X” can be an integer of, e.g., 10, 12, 20, or more devices. Further, additional technological advances, as well as an increased number of bits in the bit string, can allow 2^{N} tags or devices to be distinguished when broadcasting. “N” can be an integer of 5, 8, 10, or more, for example.

In addition, one can use a unique tag identification number as a mechanism for generating corresponding unique delays for each tag or device. Conventional software and/or algorithmic approaches can be used to convert each unique tag identification number into a bit sequence of a different length. For example, bit sequence lengths can range from 7 to 16, and can result in sufficient differentiation in terms of delays between two random tags or devices. Accordingly, any two tags under an applied set of detection conditions can be distinguished due to different bit sequences resulting from unique tag identification numbers (e.g., values and/or lengths) programmed therein.

A Second Exemplary Tag

Another exemplary tag for wirelessly communicating with a reader can include: (i) a memory portion with an identifier, where the memory portion has at least one printed layer; and (ii) a circuit for providing a bit string followed by a predetermined silent period, where the bit string is related to the identifier. The tag can include pre-programmed memory bits (e.g., bits the value of which may be programmed by printing), or alternatively, memory bits formed by conventional photolithography, but having connections made using printing technology to form the identifier, for example. A unique identifier for each tag or device used in a system under a given set of operating conditions can allow a reader to distinguish between multiple tags based on a length and/or value of a bit string, for example.

Referring now to FIG. 6B, an exemplary block schematic diagram showing a tag design in accordance with embodiments of the present invention is indicated by the general reference character 600′. In general, a printed circuit in accordance with embodiments of the present invention can include: an antenna section (e.g., 652), a power-up circuit (e.g., 654), a clock subcircuit (e.g., 656), cyclic shift registers (e.g., 658 and 660), a memory portion (e.g., 662), a delay/reset circuit (e.g., 664), and an output stage (e.g., 666). Portions of or all such circuit portions can be printable in order to reduce overall system costs. Further, “on-the-fly” customization of individual tags during the manufacturing process can also be accommodated in accordance with embodiments of the present invention.

The antenna may be implemented using a resonant LC circuit for use at 13.56 MHz, for example. Alternatively, the antenna may be implemented using a dipole or similar such antenna for 900 MHz or 2.4 GHz operation. Generally, the antenna may be used to provide power for operation of the tag circuitry, and to provide information from the tag to the reader or interrogator. Using power-up circuit 654, power can be extracted by rectifying the RF signal collected by antenna 652 and storing the resultant charge in a storage capacitor. Thus, when a tag enters a region of space with sufficient electromagnetic field being transmitted from a nearby reader, the capacitor begins to charge-up, and a voltage across the capacitor increases accordingly. When the voltage reaches a sufficient value, an “enable” signal can be generated, and this enable signal (e.g., EN) can be used to initiate circuit operation (e.g., by coupling to clock 656, cyclic shift registers 658 and 660, and the delay/reset circuit 664).

In an exemplary clocking subcircuit (e.g., 656), a clock signal can be generated so as to synchronously operate associated circuitry (e.g., cyclic shift registers 658 and 660). This clock signal may be generated by dividing down the incident RF signal received by antenna 652, by generating a local clock signal using an on-chip oscillator, or by demodulating a reader-provided clock signal from the received RF signal. This clock signal may be used to drive cyclic shift register 658, which may begin shifting a single predetermined state (e.g., a binary “high” bit) through all the rows addressing the memory, thus selecting one row of memory at a time. The output of 658 may in turn be used to clock a second cyclic shift register 660, thus shifting a single high bit through all the columns addressing the memory, thus selecting a single column of memory at a time. The memory array in accordance with embodiments of the present invention may be customized using a maskless process technology (e.g., a printing process), as described above, for 1, 2, or more layers of the tag. In an alternative embodiment, memory bits forming memory 662 may be made using conventional photolithographic techniques, and outputs thereof can be connected using maskless processing (e.g., one or more of the printing and/or laser writing/definition processes listed herein) in order to create customized bit sequences. Such a customized memory may consume less device area as compared to memory bits generated by the shift register and/or pseudo-random number generator schemes discussed above.

Bits provided from memory 662 in tag or device 600′ may be passed to output stage 666 for information (e.g., in the form of a bit string) transfer back to a reader or interrogator. The information transfer can be accomplished by modulation of the tag impedance, for example. Alternatively, other common modulation schemes, such as amplitude shift keying and/or frequency shift keying may also be used in accordance with embodiments of the present invention.

In operation, as cyclic shift registers 658 and 660 go through their sequence, various bits or portions of a predefined bit string can be transferred back to the reader. At the end of the sequence, the delay/reset circuit 664 can be triggered by the output of 660 to cause tag 600′ to “go silent” and remain in this silent state for an interval determined by the delay/reset circuit 664. This may in turn be a predetermined value, or may be determined based on various environmental or physical parameters such as temperature, power delivered to the tag, and/or electrical performance of various components within the delay circuit. When the delay circuit completes its cycle, it can reset shift registers 658 and 660, and the overall process can be repeated.

Within a period of time (e.g., 1 second), X tags can broadcast and be read/distinguished by conventional RFID systems and/or technology. “X” can be an integer of, e.g., 10, 12, 20, or more devices. Further, additional technological advances, as well as an increased number of bits in the bit string, can allow 2^{N} tags or devices to be distinguished when broadcasting. “N” can be an integer of 5, 8, 10, or more, for example.

In addition, one can use a unique tag identification number as a mechanism for generating corresponding unique delays for each tag or device by providing these as inputs to the delay/reset circuit. Conventional software and/or algorithmic approaches can be used to convert each unique tag identification number into a bit sequence of a different length. For example, bit sequence lengths can range from 7 to 16, and can result in sufficient differentiation in terms of delays between two random tags or devices. Accordingly, any two tags under an applied set of detection conditions can be distinguished due to different bit sequences resulting from unique tag identification numbers (e.g., values and/or lengths) programmed therein.

An Exemplary Method of Operating a Tag

An exemplary method of operating an identification tag or device in a wireless communication system can include the steps of: (i) programming an identifier in the tag using a printing technology; (ii) transmitting a bit string based on the identifier to a reader when the tag is in an electromagnetic field having a frequency sufficient for the tag to operate; and (iii) silencing the tag for a time period. The printing technology can include laser printing, ink jetting, gravure printing, laser writing, and/or laser definition technology, preferably using metal nanoparticle and/or liquid silane-based ink.

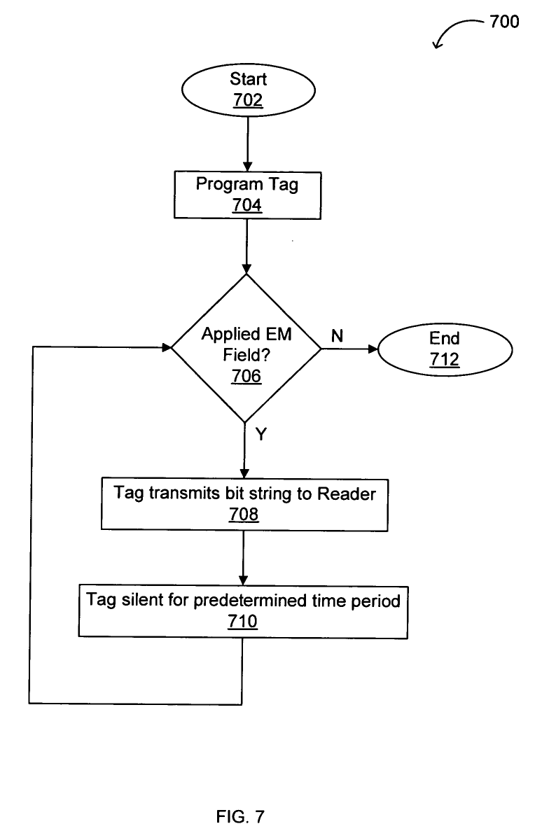

Referring now to FIG. 7, a flow diagram showing an exemplary method of tag operation in accordance with embodiments of the present invention is indicated by the general reference character 700. The flow can begin (702) and the tag can be programmed (704). As discussed above, such tag programming can include the formation of a unique identifier using printing techniques. For example, the tag can include pre-programmed memory bits (e.g., bits the value of which may be programmed by printing), or alternatively, memory bits formed by conventional photolithography, but having connections made using printing technology to form the identifier.

If no electromagnetic (EM) field is applied (706), the tag returns no information to a reader and the flow can complete (712). However, so long as an EM field is applied (706), the tag can transmit a bit string to the reader (708) and the tag can subsequently remain silent for a predetermined time period (710). The bit string transmittal followed by a silent period can repeat until the EM field is no longer applied. Further, as discussed above, different tags in a system can each have unique identifiers and transmitted bit strings (e.g., unique bit string lengths and/or values) that can be used to differentiate between those tags by an associated reader. Thus, a common or conventional reader can distinguish between different tags by monitoring bit strings from each tag, where such bit string lengths and/or values are predetermined using printing technology.

An Exemplary Wireless Identification System

An exemplary wireless identification system can include: (i) a first tag with a first identifier programmed therein using printing technology, where the first tag is configured to (repeatedly) provide or transmit a first bit string of a first length and/or value, followed by a silent period (e.g., the tag remains silent for a first period of time), when an electromagnetic field is applied, and where the first length and/or value of the first bit string and/or the first silent period is determined by an algorithm based on the first identifier; (ii) a second tag with a second identifier programmed therein using printing technology, where the second tag is configured to (repeatedly) provide or transmit a second bit string of a second length and/or value, followed by a silent period (e.g., the tag remains silent for a second period of time), when the electromagnetic field is applied, and where the second length and/or value of the second bit string and/or the second silent period is also determined by the algorithm based on the second identifier; and (iii) a reader for receiving the first and second bit strings when the electromagnetic field is applied, where the reader can distinguish between the first and second tags based on said first and second lengths and/or values and/or the first and second silent periods. Thus, one or both of the bit strings and silent periods are unique to a majority of tags (or to each tag) in a given group of tags.

The bit string lengths and/or values can include a designation of a particular type of product to be monitored, identified or detected. This information can also be used for subsequent processing in a host computer coupled to the reader or interrogator. For example, in the application discussed above whereby a tag system can be used to determine whether cars passing through a station have arranged for payment (e.g., via a debit or a credit account) to access a road, a tag in each car might provide a unique bit string and/or value to a host computer via a reader. The host computer can subsequently process this information to either allow or not allow a car access, or the host computer can debit an account associated with the car, for example. Such subsequent processing applications can be incorporated into approaches for multi-tag read capable EAS, HF, UHF and RFID systems using TTF anti-collision schemes in accordance with embodiments of the present invention.

While the above examples include particular implementations of tag circuitry, one skilled in the art will recognize that other technologies may also be used in accordance with embodiments. Further, one skilled in the art will recognize that other forms of signaling and/or control may also be used in accordance with embodiments.

The foregoing descriptions of specific embodiments of the present invention have been presented for purposes of illustration and description. They are not intended to be exhaustive or to limit the invention to the precise forms disclosed, and obviously many modifications and variations are possible in light of the above teaching. The embodiments were chosen and described in order to best explain the principles of the invention and its practical application, to thereby enable others skilled in the art to best utilize the invention and various embodiments with various modifications as are suited to the particular use contemplated. It is intended that the scope of the invention be defined by the claims appended hereto and their equivalents.

What is claimed is:

1. A tag configured to wirelessly communicate with a reader, the tag comprising:
a) a memory portion having an identifier, said memory portion comprising at least one printed layer; and
b) a circuit configured to provide a bit string followed by a predetermined, unique silent period, said bit string being related to said identifier.

2. The tag of claim 1, wherein said at least one printed layer is configured to uniquely connect a plurality of memory bits in said memory portion under a predetermined set of reader operating conditions.

3. The tag of claim 1, wherein said tag wirelessly communicates with said reader when in an electromagnetic field supplied by said reader.

4. The tag of claim 3, wherein said tag initiates said wireless communication with said reader.

5. The tag of claim 1, wherein said predetermined silent period is programmed into said memory portion.

6. The tag of claim 5, wherein a length of said predetermined silent period is determined by a counter.

7. The tag of claim 1, wherein said circuit comprises a power-up circuit coupled to an antenna, said antenna being configured to receive a radio frequency (RF) signal from said reader, said power-up circuit being configured to provide an enable signal when said RF signal is received.

8. The tag of claim 7, wherein said circuit further comprises (i) a shift register configured to select a sequence of bits in said memory and (ii) a clock circuit configured to receive said enable signal and to provide a clock signal to said shift register.

9. The tag of claim 8, wherein said circuit further comprises a reset circuit coupled to said shift register, configured to reset said shift register.

10. The tag of claim 1, wherein said circuit comprises a clock circuit coupled to a counter, said clock circuit being configured to receive an enable signal and to provide a clock signal to said counter.

11. The tag of claim 10, wherein said clock circuit is configured to receive an RF signal output from an antenna.

12. The tag of claim 1, wherein said circuit comprises a decoder coupled between a counter and said memory portion.

13. The tag of claim 1, wherein said circuit comprises a loop reset coupled to a counter, said loop reset being configured to compare a value of said counter with a predetermined reset value.

14. The tag of claim 1, wherein said circuit comprises an output stage coupled to said memory portion and an antenna, said output stage being configured to provide said bit string to said antenna for communication to said reader.

15. A method of making a tag, comprising the steps of:
a) using at least one printed layer to form a memory portion having an identifier; and
b) forming a circuit for providing a bit string followed by a unique silent period, said bit string being related to said identifier.

16. The method of claim 15, wherein the step of using said at least one printed layer comprises ink jetting.

17. The method of claim 15, wherein the step of using said at least one printed layer comprises laser writing or laser definition technology.

18. The method of claim 17, wherein said laser writing or laser definition technology uses metal nanoparticle and/or liquid silane-based ink.

19. A method of operating the tag of claim 1, comprising the steps of:
a) transmitting said bit string based on said identifier to said reader when in an electromagnetic field supplied by said reader; and
b) silencing said tag for said predetermined silent period.

20. A wireless identification system, comprising:
a) a first tag having a first identifier programmed therein using printing technology, said first tag being configured to transmit a first bit string and remain silent for a first period of time when an electromagnetic field is applied, wherein said first bit string and/or said first period of time has a length and/or value that is determined by an algorithm based on said first identifier;
b) a second tag having a second identifier programmed therein using printing technology, said second tag being configured to transmit a second bit string and remain silent for a second period of time when said electromagnetic field is applied, wherein said second bit string and/or said second period of time has a length and/or value is determined by said algorithm based on said second identifier; and
c) a reader configured to receive and distinguish between said first and second tags based on said first and second lengths and/or values.

21. The wireless identification system of claim 20, further comprising a host computer coupled to said reader.

22. The wireless identification system of claim 21, wherein said host computer is configured to perform processing based on said first and second lengths and/or values.

23. A group of tags configured to communicate wirelessly with a reader, each tag in the group comprising:
a) a first a memory portion having an identifier, said memory portion comprising at least one printed layer; and
b) a circuit configured to provide a bit string followed by a predetermined, unique silent period, said bit string being related to said identifier.

24. The group of claim 23, wherein said at least one printed layer is configured to uniquely connect a plurality of memory bits in said memory portion of each tag in the group under a predetermined set of reader operating conditions.

25. The group of claim 23, wherein each tag initiates wireless communication with said reader when in an electromagnetic field supplied by said reader.

26. The group of claim 23, wherein said unique predetermined silent period is dependent upon programming of said memory portion.

27. The group of claim 25, wherein a length of said unique predetermined silent period is determined by a counter.

28. The group of claim 25, wherein said circuit further comprises (i) a shift register configured to select a sequence of bits in said memory and (ii) a clock circuit configured to provide a clock signal to said shift register.

29. The group of claim 23, containing at least 1000 tags.
